(19) United States
(12) Patent Application Publication
(10) Pub. No.: US 2011/0029293 A1
(43) Pub. Date: Feb. 3, 2011

(54) Method For Modeling Fracture Network, And Fracture Network Growth During Stimulation In Subsurface Formations

(76) Inventors: Susan Petty, Shoreline, WA (US); Matthew Clyne, Seattle, WA (US); Trenton Cladouhos, Seattle, WA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/754,483

(22) Filed: Apr. 5, 2010

Related U.S. Application Data
(60) Provisional application No. 61/230,809, filed on Aug. 3, 2009.

(51) Int. Cl. G06F 7/60

(52) U.S. Cl. 703/2; 703/9

(57) ABSTRACT

A method for modeling fracture network and fracture network growth during stimulation in subsurface formations is disclosed. According to one embodiment, a computer implemented method comprises receiving data comprising characteristics of a subsurface formation, generating simulated fractures based upon the characteristics of the subsurface formation, simulating stimulation of the simulated fractures by creating a plurality of injection points and stimulating from every injection point of the plurality of injection points simultaneously. Simulation results are output and displayed, the simulation results including at least one of fluid volume, fluid pressure, three dimensional geometry of a stimulated volume, potential permeability enhancement, and simulated seismic activity.

The present application claims the benefit of and priority to U.S. Provisional Patent Application No. 61/230,809 entitled “METHOD FOR MODELING FRACTURE NETWORK, AND FRACTURE NETWORK GROWTH DURING HIGH PRESSURE STIMULATION IN POROUS MEDIA” filed on Aug. 3, 2010, and is hereby incorporated by reference.

### FIELD

The field of the invention relates generally to computer modeling systems. In particular, the present invention is directed to a method for modeling fracture network, and fracture network growth during stimulation in subsurface formations.

### BACKGROUND

Numerical models assist in the design of hydraulic stimulations used to enhance or develop the permeability of a natural fracture system. The goal of the numerical modeling is to model multiple design scenarios and arrive at an optimal rate, pressure and volume for each stimulation.

Various data collection techniques can be used to gain an understanding of the characteristics of naturally occurring fractures in subsurface formations. This information can be used to model the effects of stimulation upon the existing formation. Software code is necessary to model natural fracturing, growth of multiple fractures simultaneously, shear failure (as opposed to tensile failure), micro seismic events, and the ability to inject into multiple zones or fracture initiation points simultaneously.

### SUMMARY

A method for modeling fracture network and fracture network growth during stimulation in subsurface formations is disclosed. According to one embodiment, a computer implemented method comprises receiving data comprising characteristics of a subsurface formation, generating simulated fractures based upon the characteristics of the subsurface formation, simulating stimulation of the simulated fracture by creating a plurality of injection points and stimulating from every injection point of the plurality of injection points simultaneously. Simulation results are output and displayed, the simulation results including at least one of fluid volume, fluid pressure, three dimensional geometry of a stimulated volume, potential permeability enhancement, and simulated seismic activity.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

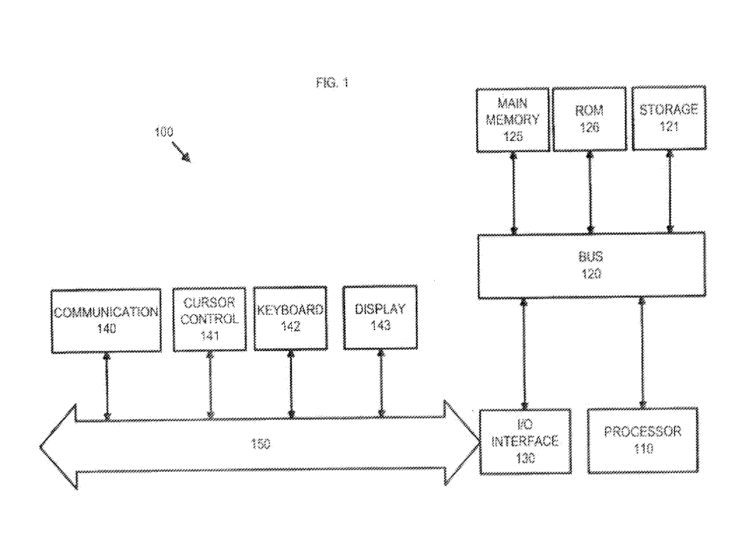

FIG. 1 illustrates an exemplary computer architecture for use with the present system, according to one embodiment.

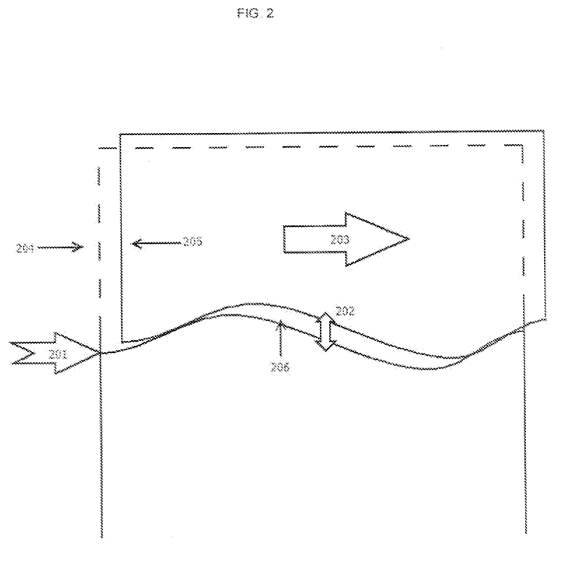

FIG. 2 illustrates an exemplary shear dilation.

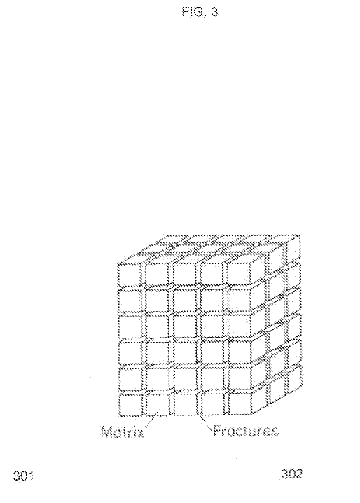

FIG. 3 illustrates an exemplary fractured reservoir.

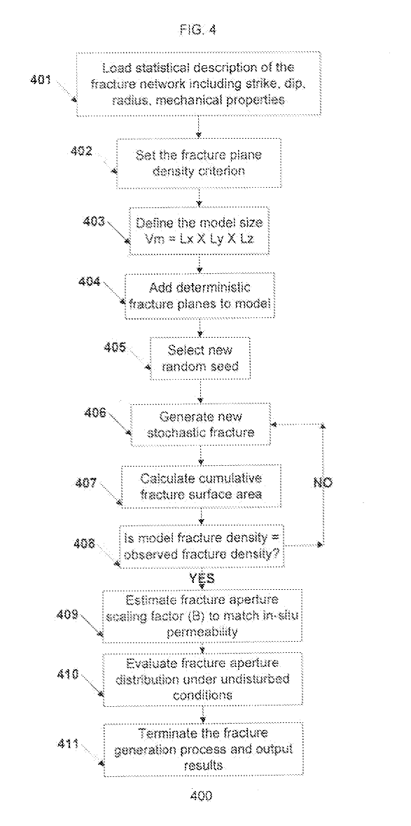

FIG. 4 illustrates an exemplary process for generating a single fracture network realization within the present system, according to one embodiment.

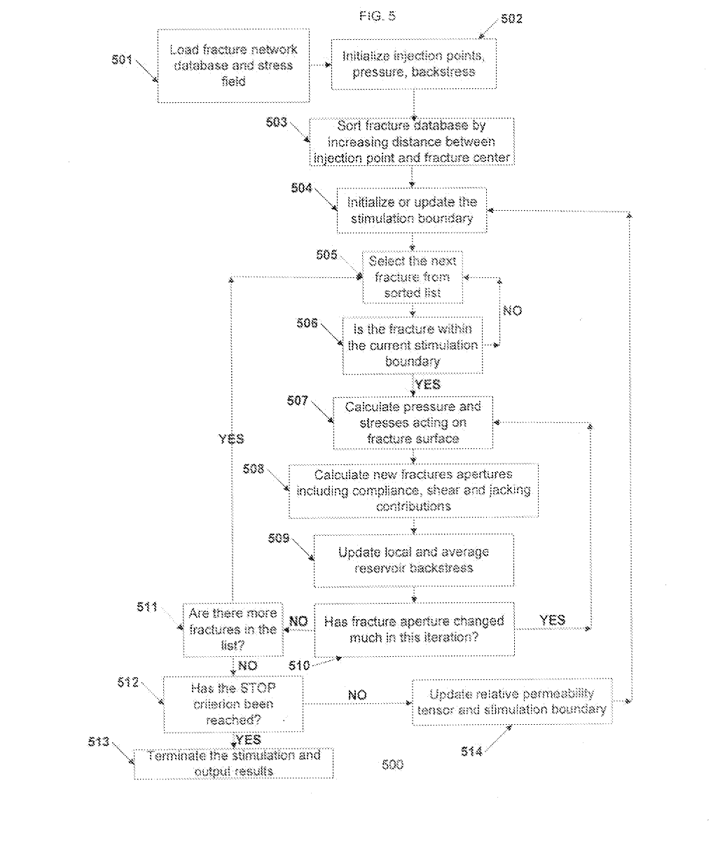

FIG. 5 illustrates an exemplary calculation process for modeling within the present system, according to one embodiment.

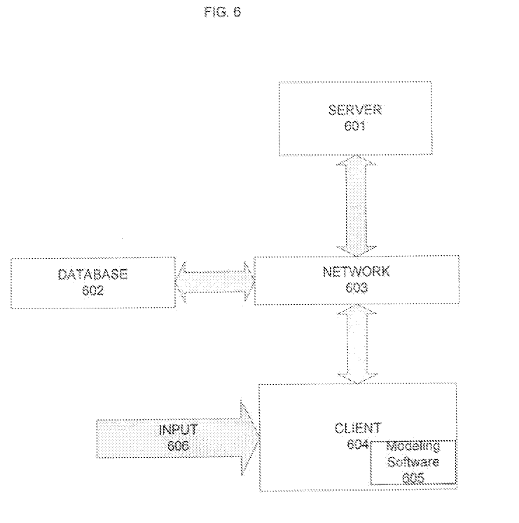

FIG. 6 illustrates an exemplary architecture of the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method for modeling fracture network and fracture network growth during stimulation in subsurface formations is disclosed. According to one embodiment, a computer implemented method comprises receiving data comprising characteristics of a subsurface formation, generating simulated fractures based upon the characteristics of the subsurface formation, simulating stimulation of the simulated fracture by creating a plurality of injection points and stimulating from every injection point of the plurality of injection points simultaneously. Simulation results are output and displayed, the simulation results including at least one of fluid volume, fluid pressure, three dimensional geometry of a stimulated volume, potential permeability enhancement, and simulated seismic activity.

According to one embodiment, the present system includes a software modeling tool that simulates the creation of an engineered reservoir or the enhancement of a naturally fractured low permeability reservoir. The software modeling tool simulates the creation of the engineered reservoir by stochastically modeling naturally occurring fractures in a subsurface formation and then modeling the propagation of those fractures via hydraulic stimulation. The model for use within the present system, according to one embodiment, utilizes the fracture modeling algorithm described by Willis Richards et al. (Willis-Richards, J., K. Watanabe, and H. Takahashi (1996), Progress toward a stochastic rock mechanics model of engineered geothermal systems, J. Geophys. Res., 101(88), 17,481-17,496). The fracture modeling algorithm approach proposes the use of several equations to model various facets of stimulation. Original fracture modeling algorithm equations used in the present system include the following:
Stress equations

σₙ=(σ₁ Cos²λ+σ₂ Sin²λ)Sin²θ+σ_{z} Cos²θ=σ_{zz}

τ₂₃=−½(σ₁−σ₂)Sin θ×Sin 2λ=σ_{yz}

τ₁₃=½(σ₁ Cos²λ+σ₂ Sin²λ−σ_{z})Sin 2θ=σ_{xz}
Change in fracture aperture due to stress

α=αₓ/(1+9σ/σ_{mnf})+αₓ
Shear slip equation

U=(τ−σ tan(φ_{xzy}−φ_{xzy}))/Kₓ

The fracture modeling algorithm approach can reasonably be considered a scoping tool that enables the rapid testing and evaluation of a large number of stimulation scenarios. The output from the model allows the uncertainty in the stimulation process to be assessed and some key engineering decisions to be made, such as the potential variability in the stimulation fluid volume and the hydraulic and thermal performance of the reservoir.

As noted above, the fracture modeling algorithm approach does not treat the stimulation as a dynamic, hydraulic process. Rather it considers a series of static assumptions of the pressure field within a rock mass. This simplification reduces the execution time for each realization dramatically and enables the investigation of a statistically meaningful number of realizations.

According to one embodiment, the present system includes three components:

1) Fracture network database generation (stochastic fracture modeling);
2) Stimulation (models hydraulic stimulation); and
3) Converting output into useful formats, including mapping to an Equivalent Porous Medium (EPM) grid.

According to one embodiment, the present system enables rapid testing and evaluation of a large number of different stimulation scenarios.

According to one embodiment, the present system accounts for the uncertainty inherent in trying to describe a natural rock mass system and aims to capture the approximate hydro-mechanical behavior of the fracture system during stimulation.

According to one embodiment, the present system does not, however, account for the dynamics of fluid flow in the fracture network, but instead models the stimulation in a series of static steps.

According to one embodiment, the present system can be utilized to produce estimates for water volume, pump rate, pumping pressure, and hydraulic horsepower to aid in mitigating risk inherit in stimulation. Outputs of the present system include but are not limited to Equivalent Porous Medium (EPM) grids, TecPlot files, LiveGraphics3D files, micro seismic events, and plain text. Exemplary outputs of the present system include:
Stimulation fluid volume: provides the range of fluid volumes and pressures that might be required to achieve the target stimulated volume and/or well separation. This aids the planning of the injection interval lengths, water supply, and scheduling of operations.
3D reservoir geometry: Captures the potential variation in 3D geometry of the stimulated volume, such as the tendency for upwards, downwards and/or asymmetric horizontal growth. This information helps in planning the subsurface and surface position of production wells, and in defining the stages in a multi-stage stimulation.
Circulation model input: Provides a population of stimulated fracture networks that represent the variability in the outcome of the stimulation process. These can be used in an Equivalent Porous Medium (EPM) model to investigate circulation and long term thermal recovery.
Simulated micro seismic clouds: Provides a statistical estimate of the micro seismic event cloud that might be generated during the stimulation. This is useful in designing the resolution and sensitivity of the micro seismic monitoring system.

The present system provides the ease of processing large amounts of data through the user interface. Additional advantages include the iterative nature of the modeling. Any series of steps can be re-evaluated, increasing the accuracy of the model.

According to one embodiment, modeling, using the present system, can also be a collaborative process. Utilizing Visual Basic to interact directly with Microsoft Excel, multiple fracture network databases generate and process all data with relative ease, for example. Monte Carlo simulation techniques are used to acquire vast amounts of reservoir data for finding best fits, means, medians, and averages for similar fracture network databases. Using these techniques, the present system accurately predicts the behavior of a given formation body under stimulation in the least amount of time possible.

According to one embodiment, the present system includes a user-friendly interface, incorporating user familiarity with Microsoft Excel and a friendly programming interface.

The present system includes data management (data input and output) and the file structure of solutions that allow visualization and manipulation of the data in meaningful ways.

The present system creates accurate input meshes for use in TOUGH2 modeling. TOUGH2 is a general-purpose numerical simulation program for multi-phase fluid and heat flow in porous and fractured media. The inclusion of this output enables the dynamics of fluid flow in the fracture network produced by the present system to be analyzed.

The present system models the simultaneous stimulation of two or more wells. The present system allows for the linear summation of the pressures within the separate stimulation boundaries from each injection well by updating the relative permeability tensor and stimulation boundaries in the model. The present system defines no upper limit to the number of simultaneous injection points.

### Stimulation Objectives

One objective of a stimulation is to enhance the permeability within a specified target rock volume (i.e. m³) that will then form all or part of a subsurface reservoir. This volume is most frequently expressed in terms of the injector and producer well separation required to achieve the target circulation volume. Hence the primary stimulation design parameters are the fluid pressure and the fluid volume (i.e. flow rate and duration) that will achieve this stimulated volume. Other stimulation parameters, such as the fluid density and viscosity, also have an effect, but these are essentially additional controls on the pressure field and injected fluid volume.

### Stimulation Performance Criteria

According to one embodiment, assessments provided by the present system include:

1) Fluid volume (i.e. flow rate and time) and pressure required to achieve the target stimulated volume and/or well separation;
2) 3D geometry of the stimulated volume, as controlled by the interaction of the fluid pressure, in situ stress regime and natural fracture network; and
3) Permeability enhancement that may be achieved by the stimulation as expressed by a population of stimulated fractures with associated apertures, orientations and sizes (i.e. radius).

### Fracture Model Data Collection and Fracture Generation

According to one embodiment, forward modeling creates a first look at fracture network characteristics and a stress regime prior to generating a fracture model. The data can be collected during operations, compiled from previous ventures, and summarized from coring and televiewer data. Fracture characteristics that are collected include orientation, size, spacing, and aperture. Stress state and rock mechanics are also collected. A numerical model representing the naturally occurring fractures is created.

Input parameters for fracture generation include data about the model region (e.g. size and center point), formation stresses and alignment, fracture classes (e.g. strike, dip, radius), and a number of models to generate.

### Stimulation Model Requirements and Stimulation Process

During the stimulation process fluid is injected into a formation at a pressure less than or equal to the minimum effective stress (s′ min). Fluid migrates from the injection borehole through the fracture system causing the fractures to:

a. Open elastically in a direction normal to the fracture surface (normal compliance), and
b. If the pressure is sufficient to overcome the frictional strength of the fracture, the fracture will also fail in shear. During shearing the asperities (roughness) on the fracture surface result in an irreversible normal deformation known as “shear dilation.” The misalignment of the “saw-tooth” asperities acts as “self-propping” that holds the fracture surfaces apart.

The shear dilation forms the bulk of the permanent increase in fracture aperture during reservoir stimulation. When the pressure is reduced the elastic (compliant) component of the fracture aperture is reversible, but the shear dilation remains.

Therefore the following assumptions are made about the stimulation process:

1. The formation composition consists of a relatively impermeable matrix intersected by a network of interconnected faults, joints and fractures—hereafter termed “fractures.”
2. Fluid flow and storage is confined entirely to the fracture system, with a zero contribution from the matrix. This is referred to as a “Type-1” fractured reservoir.
3. No new fractures are created through “classic hydraulic fracturing” (i.e. through tensile failure of intact rock). If hydraulic fracturing occurs, however, it is assumed that it will be confined to the near-wellbore region and as soon as any natural fractures are intersected those fractures will then form the path of least resistance to fluids. In other words the reservoir behavior becomes dominated by the pre-existing fracture network as soon as it is intersected.
4. Permanent permeability enhancement occurs only through the increase in fracture aperture resulting from shear displacement of the fracture surfaces.
5. Temporary (transient) changes in fracture aperture occur through elastic compliance of the fractures due to changes in fluid pressure. Hence this component of the fracture aperture and permeability is dependent on the ambient pressure field, be it under stimulation, circulation or hydrostatic conditions.

According to one embodiment, fracture stimulation input parameters include boundaries, injectors, and legs (legs determine accuracy of the pressure boundary growth).

### Stimulation Design Uncertainties

Uncertainties in stimulation modeling and design include:
1. Fracture distribution—including the spatial distribution, size, orientation, apertures and mechanical properties of the individual fractures and fracture families; and
2. Stress field—including the magnitude and orientation of the principal stresses, and importantly their variation with depth.

Typically, a statistical description of the fracture network is available. It is likely to be based upon some combination of surface mapping, borehole image logs and possibly core. There are also constraints on the stress field based on regional stress trends, natural seismicity and/or various borehole measurements.

In some cases the knowledge of the stress and overall fracture pattern are very good, but nonetheless the specific distribution of fractures within the target rock mass is still unknown.

Stimulation modeling is therefore considered a “data limited” problem, where the specific outcome of any stimulation cannot be accurately predicted beforehand. However, by considering the uncertainty in the input parameters (stress and fracture distribution) it is possible to assess the uncertainty in the outcome of the stimulation and then take the uncertainty into account in the engineering design.

The uncertainty is investigated by running a large number of model stimulations using statistically defined “realizations” of the in situ stress and fracture conditions and then analyzing the distribution of output reservoirs. These realizations are generated stochastically by sampling the empirically derived probability distribution functions that describe the stress and fracture distribution.

### Realistic Model Outputs

Referring back to the stimulation performance criteria outlined above, the present stochastic stimulation design model is therefore useful in determining:

1) The range of fluid volumes and pressures that are required to achieve the target stimulated volume and/or well separation. Specifically the minimum, maximum and most likely fluid volumes required. This aids in the planning of the injection interval lengths, surface plant, water supply and scheduling of operations.
2) The potential variation in 3D geometry of the stimulated volume, such as the tendency for upwards, downwards and/or asymmetric horizontal growth. The results can be expressed in terms of an average reservoir shape, and extreme end-members. This knowledge helps in planning the subsurface and surface position of production wells, and in defining the stages in a multi-stage stimulation.
3) A population of stimulated fracture networks (i.e. permeability fields) that represent the variability in the outcome of the stimulation process. These are valuable in assessing the potential variation in the hydraulic performance during circulation, and in particular the potential for short circuiting. This is then taken into account by allowing for increasing the well spacing and/or open hole lengths.
4) A statistical estimate of the micro seismic event cloud that may be generated during the stimulation. This is useful in designing the resolution and sensitivity of the micro seismic monitoring system.

The uncertainty in the stress and fracture distribution, in the size of the fracture populations being treated, and also in the highly non-linear physics of the stimulation process make it impractical to use complex coupled models for stimulation design. Complex coupled models typically simplify the geometry of the fracture system that can be examined and/or are not amenable to a large number (100's) of model “realizations.”

From an engineering perspective it is much more helpful to simplify the physics where possible and aim to capture the uncertainty in the outcome of the stimulation process. As a result, the engineering can aim to reduce the effect of the uncertain outcome and build in flexibility to subsequent development stages (e.g. drilling of production wells).

Therefore, according to one embodiment, the present system implements a stochastic model to provide the stimulation performance criteria described above as its primary output. The present system generates a fracture growth model and computes seismicity. The present system provides a statistical representation of the micro seismic cloud generated during stimulation and provides input into a flow model, such as TOUGH2, to evaluate the performance under circulation.

### Stimulation Modeling

The stimulation modeling of the present system is based on algorithms that contain approximations of the coupled physical processes, yet capture the uncertainty in the fracture geometry and mechanical properties.

According to one embodiment, simplifications in the model include:
1. No dynamic solution for fluid flow within the fracture system—rather the model considers a series of static estimates of the evolution of the pressure field within the rock mass.
2. No explicit treatment of the spatial relationship of individual fractures. It is reasonably assumed that the fracture network is well connected.

### Software Modules of the Present System

According to one embodiment, the present system includes three software modules:

1) Fracture network database generation

### 2) Stimulation; and

3) Mapping to an Equivalent Porous Medium (EPM) grid.

The software modules of the present system are described below in FIGS. 4 and 5.

### Data Conversion

According to one embodiment, output from the present system is converted to useful formats for further reviewing and modeling. Multiple fracture models are analyzed for determining error and means using Monte Carlo methods. Seismic output can be visualized for easy visual model verification.

### Validation and Verification

Fracture classes in the 8,000 km³ region are modeled. Predictions of micro seismicity generated by the present system are compared to actual data. Sensitivity analysis identifies limits for field parameters for optimal stimulation design.

### Parameters

Input and output parameters of the present system, according to one embodiment, include but are not limited to:

Fracture generation Inputs:

Run Parameters:
NumModels (number of models to create)
Seed (number used as seed for randomization)

Region Information:
X, Y, Z (x, y, z location of center of region)
X Length, Y Length, Z Length (dimensions of region)
Frac Density (desired density of fractures [stop criteria])
Permeability (existing permeability of region)

Stress Information:
Vert Stress gradient (vertical stress gradient)
VS Intercept (vertical stress intercept)
Greatest Horiz Stress Grad (greatest horizontal stress gradient)
Greatest Horiz Stress Intercept (greatest horizontal stress intercept)
Least Horiz Stress Grad (least horizontal stress gradient)
Least Horiz Stress Intercept (stress orientation and magnitudes)
Fluid Grad (Magnitude of additional fluid pressure)
Fluid Staticant (addtl pressure calc due to altitude)
Greatest Horiz Stress Orientation

Fracture Information:
FracClasses (number of different fracture types to model)
Frequency (relative frequency of this particular fracture class)
Friction angle (basic friction angle)
Shear angle (basic shear angle)
Closure Stress (stress required to close frac to 90% unstressed aperture)
Unstressed Aperture
Str Avg (Average fracture angle of strike)
Str Deviation (standard deviation from the average)
Dip Avg
Dip Deviation
Frac Min Rad (minimum fracture radius)
Frac Max Rad (maximum fracture radius)
Fractal Density (used in determining backstress)

Fracture Generation Outputs:
fX, fY, fZ (x, y, z location of fracture)
fClass (fracture class this fracture belongs to)
fStrike, fDip (Strike, dip of fracture [orientation])
fRadius (fracture radius)
fPhiB (friction angle)
fPhiD (shear angle)
fSnRef (90% closure stress)
fAzero (relative initial aperture)
fSNtotal (total normal stress acting on fracture)
fSSMax (shear stress acting on fracture)
tAzero (0% stress aperture)
fAperture (actual fracture aperture)
fDistance (Distance from center of region)
Average Aperture (Average size of fracture apertures for all fractures)
Fracture Count (Total number of fractures generated)
Run Time (Total execution time in seconds of module)

Fracture Stimulation Inputs:

Run Parameters:
Initial P Boundary (initial length of boundary legs)
Boundary Increment (Maximum length increment of boundary leg in a step)
Pressure Drop (rate pressure drops away from injection point)
Boundary Resolution (Number of legs used to define boundary)
# of injectors (total injectors used)

Rock Properties:
Coeff Friction (Base friction coefficient as an angle relative to fracture surface)
Additional Friction (Friction associated with fracture surface irregularities)
Young's Modulus (modulus of elasticity of formation)
Poisson's Ration (Ratio of stress in transverse from direction of application)

Runtime Options:
Create Seismics (create seismic outputs)
Create Diagnostics (creates additional output for analysis of models performance)
Compute Backstress (Option to not include backstress computation)

Termination Criteria: (module terminates when . . . )
Termination Volume (stimulated volume matched)
Termination Length (maximum boundary leg length reached)
Termination Cycles (Module has executed a particular number of “cycles”)

Injector Data:
X, Y, Z (x, y, z location of injector)
Pressure (pressure at injector)
P Decline (rate of decline of pressure away from injector)

Fracture Stimulation Outputs:
Stop Mechanism (which stop criteria was met)
Model Volume (total volume of model region as defined in first module)
Initial Frac Volume (initial volume of all fractures)
Initial Frac Porosity (initial porosity of all fractures)
Stimulated Volume (total volume stimulated)
Final Frac Volume (total volume of all fractures after stimulation)
% volume stimmed (Percentage of total volume stimulated)
Final Frac Porosity (porosity of all fractures after stimulation)
Stimmed (number of fractures stimulated)
Fracced (number of fractures shear stress exceeded normal stress)
Sheared (number of fractures that slipped or sheared)
Jacked (number of fractures “jacked” open beyond normal stress)
Cycles (number of cycles executed by module)
Time(hours) (estimated time in real hours stimulation would take)
Ave. sheared ap. (average final aperture of all stimmed fractures)
Max Leg (length of longest boundary leg)
Run Time (run time of module execution in seconds)

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 125 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary shear dilation. During stimulation, fluid enters the fracture 201, applying force in the direction normal to the fractures face 202. If the stimulation pressure is great enough to overcome the friction on the face of the fracture, shearing will occur 203. As shearing occurs, the faces of the fracture will move from their original position 204 where the fracture is very tight, to their new position 205. The increase in the fracture's aperture 206 is known as shear dilation, and is a lasting effect.

FIG. 3 illustrates an exemplary fractured reservoir. The reservoir in a subsurface formation 301 exists in the gaps between relatively impermeable masses 302. It is easiest to understand when simplified in the manner of FIG. 3. The matrix represents the relatively impermeable mass bodies, and the fractures are represented by the spaces between. When a reservoir is stimulated, the size and length of the gaps is increased, thus improving permeability.

FIG. 4 illustrates an exemplary process for generating a single fracture network realization within the present system, according to one embodiment. A process for generating a single fracture network realization 400 begins with loading a statistical description of the fracture network including strike, dip, radius, and mechanical properties 401. The fracture plane density criterion are set 402 and the model size is defined (Vm=Lx×Ly×Lz) 403. Deterministic fracture planes are added to the model 404 and a new random seed is selected 405. A new stochastic fracture is generated 406 and the cumulative fracture surface area is calculated 407. The equivalency of the model fracture density and the observed fracture density is tested 408 and if they are not equal the process 400 returns to generating a new stochastic fracture 406. If they are equal then a fracture aperture scaling factor (β) is estimated to match in-situ permeability 409. Fracture aperture distribution is evaluated under undisturbed conditions 410 and the process is terminated and results are output 411.

The fracture generation process continues until the fracture density within the modeled region matches field observations. The fracture density is estimated by summing the total fracture area generated within the model (Spr2) and dividing by the total model volume (Vm=Lx×Ly×Lz).

The initial fracture apertures are calibrated against the measured (or assumed) undisturbed permeability of the system. This process uses a scaling factor β, which is derived under the reasonable assumption of an approximately parallel plate fracture distribution.

In addition to stochastic fractures, specific deterministic (i.e. known or assumed) fractures are added to the model. This addition is useful for incorporating:
Specific mapped fractures that intersect the borehole, thus helping ensure an adequate match to near-wellbore behavior; and
Any large scale far-field faults or fractures mapped during exploration. This is useful if the faults are likely to act as fluid sinks, flow barriers or as possible sources of large scale induced seismicity.
   FIG. 5 illustrates an exemplary calculation process for modeling within the present system, according to one embodiment. A network of circular fractures is generated by randomly sampling the defined distribution of fracture location, orientation, radius, in-situ aperture and mechanical properties. Fractures continue to be generated within the model volume until the total number of fractures matches the known or estimated fracture plane density. For a 3D representation of the fracture network this can be quantified in terms of the mean fracture surface area per unit volume of rock. According to one embodiment, the overpressure within the open hole section is assumed to be constant during the entire stimulation operation.

According to one embodiment, the stimulation proceeds in a series of discrete spatial steps, through which the boundary of the stimulation propagates out through the fracture network. These steps are analogous to an increasing injection time, but there is no explicit consideration of the dynamics of fluid flow. It is assumed that the overpressure (deltaPstim) in the stimulation volume decreases linearly from the injection borehole to the current stimulation boundary. The initial stimulation boundary is defined by a series of spheres of adjustable radius, originating at the defined injection points. The assumption of a relatively small linear decline in pressure to the stimulation boundary is consistent with the results of numerical simulations where the pressure gradients within the stimulated fractures are small, due to their large apertures.

An exemplary calculation process 500 begins with loading a fracture network database and stress field 501. Injection points, pressure, and backstress are initialized 502 and the fracture database is sorted by increasing distance between injection point and fracture center 503. The stimulation boundary is initialized or updated 504 and a fracture is selected from the sorted list 505. The fracture is tested, whether it is within the current stimulation boundary 506. If it is not, another fracture is selected 504 and the process 500 continues. If it is within the current stimulation boundary 506, the pressure and stresses acting on the fracture surface are calculated 507. The new fracture's apertures are calculated 508, including compliance, shear, and jacking contributions. The local and average reservoir backstresses are updated 509, and the fracture aperture is tested for significant change in the iteration 510. If the fracture aperture has changed significantly, then the process 500 returns to calculate the pressure and stresses acting on the fracture surface 507 and continues. If the fracture aperture has not changed significantly, the list is checked for more fractures 511. If there are no more fractures in the list, and the STOP criterion has been reached 512 then the process terminates and results are output 513. If there are more fractures in the list then the process 500 returns to select the next fracture from the sorted list 505 and continues. If there are no more fractures in the list and the STOP criterion has not been reached then the relative permeability tensor and stimulation boundary are updated 514 and the process 500 returns to updating the boundary 504 and continues.

According to one embodiment, STOP criterion include:
Reaching a total injected fluid volume, as derived from the summed fracture aperture increase;
Achieving a predefined total stimulated rock volume (i.e. m³);
When the most distant stimulated fracture equals a predefined target well separation; or
When the upwards or downwards growth exceeds a predefined limit.

According to one embodiment, the mechanical deformation is calculated for all fractures contained within the current stimulation volume at each step in the calculation process 500. This includes changes in fracture aperture due to normal compliance, shearing and also jacking, which is tensile opening at zero effective stress. Every stimulated fracture contributes to an average elastic backstress, which is a compression of the reservoir due to the sum of all additional fracture apertures. This backstress is used to correct the principal stress components and fracture apertures, such that they are in equilibrium.

According to one embodiment, an apparent permeability tensor is updated after every step in the calculation process 500. This describes the relative improvement in conductivity in all directions within the 3D reference frame. The permeability tensor is used to define the stimulation boundary for the next stimulation step. The extent of the stimulation boundary in any direction is directly proportional to the relative permeability. The growth of the present stimulation mimics the way in which actual stimulations are controlled by the interaction of the fracture network and stresses.

Sorting the fracture database by the distance from the injection point means that the stimulation progresses in a logical fashion away from the injection borehole. In addition, since the fractures are sorted by distance, time can be saved by ignoring all fractures in the list after a fracture is determined to be beyond the longest leg of the stimulation area. This is particularly effective in decreasing computation in the early iterations of the stimulation module as the stimulation boundaries are relatively small compared to the total volume.

According to one embodiment, before updating the fracture apertures, the stresses acting on the individual fracture surfaces are resolved and then the deformation is calculated, including testing for shearing and shear dilation. Any change in fracture aperture results in a change in the backstress acting on the fracture itself and also in the overall backstress generated by the inflated fracture system.

The equilibrium point between the current fracture aperture and the induced backstresses is unknown a-priori. Therefore it is necessary to perform some iteration around the aperture and backstress calculation until the equilibrium point is reached. The iterative process appears to have been adopted in all implementations of fracture modeling algorithm and is relatively straight-forward to implement.

According to one embodiment, once the stimulated fracture population exceeds a few 10's of fractures the reservoir backstress converges to a stable value and the requirement for iteration is significantly reduced. At this point, computation power can be conserved by adopting a static value for backstress.

According to one embodiment, the calculation process 500 updates the relative permeability tensor and the stimulation boundary. Several approaches have been adopted ranging from a regular (i.e. ellipsoidal) boundary increment described by described by Willis Richards et al. (Willis-Richards, J., K. Watanabe, and H. Takahashi (1996), Progress toward a stochastic rock mechanics model of engineered geothermal systems, J. Geophys. Res., 101(B8), 17,481-17,496) to a non-uniform envelope described by Kohl and Megel (Kohl T. and Megel T., 2005 “Numerical modelling of hydraulic stimulations at Soultz-sous-Forêts”). The non-uniform approach is chosen as it allows for asymmetric growth of the stimulation, and hence is a more realistic representation of spatial uncertainty. However the non-uniform boundary can introduce significant computational complexity as it requires the tracking of an asymmetric boundary condition and the testing of whether the latest fracture falls within the boundary. The complexity of this approach has been mitigated some by the approach adopted by this method. The boundary at each injection point is represented by an assignable number of “spider legs” which can be incremented in length separately. Thus, each fracture is assigned to the leg which it is closest too, and only has to test whether its distance from the injection point is less than the length of the leg to determine if it falls within the boundary. The increase in leg length is determined by evaluating the degree to which fractures in the leg's boundary are stimulated and their orientation relative to the vector of the leg.

FIG. 6 illustrates an exemplary architecture of the present system, according to one embodiment. A server 601 is in communication with a network 603, and a database 602 is in communication with the network 603. A client device 604, having modeling software 605 installed thereon, is in communication with the network 603. The client device 604 receives input 606. The input 606 can be received from a microseismic monitoring system as well as from pump trucks and other instrumentation through an I/O system, according to one embodiment. The client device can also compare output from the modeling software 605 to the input 606 and control a stimulation process accordingly. According to one embodiment, the server 601 has modeling software installed thereon as well. The client device 604, server 601, and database 602 have architectures similar to that described in FIG. 1, according to one embodiment.

A method for modeling fracture network and fracture network growth during stimulation in subsurface formations has been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method, comprising:
receiving data comprising characteristics of a subsurface formation;
generating simulated fractures based upon the characteristics of the subsurface formation;
simulating stimulation of the simulated fractures by creating a plurality of injection points and stimulating from every injection point of the plurality of injection points simultaneously; and
outputting and displaying simulation results, the simulation results including at least one of fluid volume, fluid pressure, three dimensional geometry of a stimulated volume, potential permeability enhancement, and simulated seismic activity.

2. The computer-implemented method of claim 1, wherein the characteristics of the subsurface formation are based upon real-time data and are at least one of known characteristics and predicted characteristics.

3. The computer-implemented method of claim 2, wherein the predicted characteristics are determined using Monte Carlo simulation methods.

4. The computer-implemented method of claim 1, further comprising calculating a predicted growth of fracture aperture and radius to produce a calculation, wherein the calculation correlates with an increase in permeability.

5. The computer-implemented method of claim 1, wherein simulating stimulation of the simulated fracture uses two-dimensional modeling approach algorithms.

6. The computer-implemented method of claim 1, wherein stimulation of the simulated fracture is dominated by shear fracturing.

7. The computer-implemented method of claim 1, wherein each injection point of the plurality of injection points is assigned a number of spider legs to control a stimulation boundary.

8. The computer-implemented method of claim 1, wherein a format of the simulation results includes at least one of TecPlot graphic output, plain text, TOUGH2 input, equivalent porous medium (EPM) grids, and LiveGraphics3D simulated seismic event files.

9. A system, comprising:
a server in communication with a network, wherein the server is in communication with a database over the network; and
a client device in communication with the network, the client device having instructions stored thereon, the instructions, when executed by the client device, causing the client device to:
receive data comprising characteristics of a subsurface formation;
generate simulated fractures based upon the characteristics of the subsurface formation;
simulate stimulation of the simulated fractures by creating a plurality of injection points and stimulating from every injection point of the plurality of injection points simultaneously; and
output and display simulation results, the simulation results including at least one of fluid volume, fluid pressure, three dimensional geometry of a stimulated volume, potential permeability enhancement, and simulated seismic activity.

10. The system of claim 9, wherein the characteristics of the subsurface formation are based upon real-time data and are at least one of known characteristics and predicted characteristics.

11. The system of claim 10, wherein the predicted characteristics are determined using Monte Carlo simulation methods.

12. The system of claim 9, further comprising calculating a predicted growth of fracture aperture and radius to produce a calculation, wherein the calculation correlates with an increase in permeability.

13. The system of claim 9, wherein simulating stimulation of the simulated fracture uses two-dimensional modeling approach algorithms.

14. The system of claim 9, wherein stimulation of the simulated fracture is dominated by shear fracturing.

15. The system of claim 9, wherein each injection point of the plurality of injection points is assigned a number of spider legs to control a stimulation boundary.

16. The system of claim 9, wherein a format of the simulation results includes at least one of TecPlots, plain text, TOUGH2 input, equivalent porous medium (EPM) grids, and LiveGraphics3D files.
